(19) United States
(12) Patent Application Publication
(10) Pub. No.: US 2004/0156167 A1
(43) Pub. Date: Aug. 12, 2004

(54) Switchgear cabinet comprising a door for an electric switching installation

(76) Inventors: Volker Kopke, Puschendorf (DE); Stefan Lebek, Halle (DE); Gildo Mahn, Munchen (DE); Helmut Schriefl, Domigheim (DE); Brunhilde Wenge, Eichenbarleben (DE)

Correspondence Address: MORRISON & FOERSTER LLP, 1650 TYSONS BOULEVARD, SUITE 300, MCLEAN, VA, 22102, US

(21) Appl. No.: 10/479,742

(22) PCT Filed: May 24, 2002
(86) PCT No.: PCT/DE02/01988

(30) Foreign Application Priority Data
Jun. 6, 2001 (DE) 101 27 864.0

(51) Int. Cl. H02B 1/04; H02B 1/26

(52) U.S. Cl. 361/647

(57) ABSTRACT

To permit the locking of a displaceable door (1), comprising a door frame (2, 3, 4, 5, 6), which gives the door mechanical stability and a door leaf (3), which is attached to the door frame (2, 3, 4, 5, 6), the door leaf (8) is configured so that it can be displaced in relation to the door frame (2, 3, 4, 5, 6). The door leaf (8) is allocated first locking elements (12a, b), which can be locked and unlocked with second locking elements (12c, d) that are allocated to the switchgear cabinet frame by the displacement of the door leaf (8).

The invention relates to a switch cabinet for electrical switchgear, having a door which can be moved in relation to a switch-cabinet frame and has a door frame, which provides the door with mechanical stability, and a door leaf, which is arranged on the door frame.

Such a switch cabinet is known, for example, from laid-open application DE 43 12 025 A1. The switch cabinet in the latter document has a door which is mounted in a pivotable manner on the switch cabinet by means of hinges. The pivotably mounted door can be moved via a lifting mechanism from a lowered locking position into a raised pivoting position and from the raised pivoting position into the lowered locking position. During lowering of the door in the closed state, rear-engagement locking elements engage with one another and lock the door. The door thus has advantageous mechanical properties in respect of forces acting on it.

The object of the present invention is to design a switch cabinet of the type mentioned in the introduction such that, along with a simplified design of the door, the function of the latter is improved.

The object is achieved according to the invention, in the case of a switch cabinet of the type mentioned in the introduction, in that the door leaf can be moved relative to the door frame and the door leaf is assigned first locking elements which can be locked with second locking elements assigned to the switch-cabinet frame, and unlocked therefrom, by virtue of the ability of the door leaf to move in relation to the switch-cabinet frame.

In contrast to the known solution, it is now no longer necessary to raise and lower the entire door for closing and opening purposes. Since now only part of the door has to be moved, a relatively straightforward mechanism may be provided. In the case of a door which is mounted in hinges, it is now no longer necessary for the hinges to allow raising and lowering of the entire door. Accordingly, it is possible to use more straightforwardly designed standard hinges. The door frame, which provides the door with mechanical stability, is not incorporated in the locking mechanism. It is merely the door leaf which is assigned first locking elements, which can be brought into engagement with second locking elements. The door frame serves exclusively for mechanically stabilizing the door.

Furthermore, it may advantageously be provided that, with the door frame fixed in the closed position of the door, the door leaf can be moved in relation to the switch-cabinet frame.

Such a design advantageously avoids locking movements and opening movements of the door coinciding. Once the door has been unlocked by movement of the door leaf in relation to the switch-cabinet frame, opening of the door is made possible, for example, by pivoting of the door frame. The operations of opening the door and unlocking the door here are two independent movement operations, with the result that accidental opening of the door during unlocking is avoided. This design solution simplifies the operability of the cabinet door. The situation where locking and opening movements of the door coincide is thus ruled out.

It may advantageously be provided that the first and the second locking elements are each of comb-like design.

Comb-like locking elements are easy to produce. In the case of a corresponding configuration of the first and second locking elements, the latter may be of virtually identical design. A comb-like design results, in the locked state, in a relatively large surface area over which the locking elements engage behind one another. This ensures a high level of mechanical strength for a locking means designed in this way.

It may advantageously be provided that the first locking elements are arranged on a door edge which is located opposite an attached door edge.

Such an arrangement of the first and of the second locking elements advantageously allows the locking elements to be guided past one another when a door is pivoted closed or pivoted open. All of the first and second locking elements are located virtually simultaneously in the same positions relative to one another. This rules out problems such as, for example, the operation of individual locking elements being pivoted in one after the other. In conjunction with the attachment means, for example hinges, which are provided for attaching the pivotable door, the door can be closed and locked very easily.

It may further be provided that the first locking elements are each arranged along two parallel door edges.

Selecting two parallel door edges makes it possible, irrespective of the selection of moveable door, for example of a pivotable door or of a sliding door, to maintain the design for locking the door. The selection along two parallel door edges makes it possible to improve the mechanical loadability of a door which is closed in this way. The forces which arise can be absorbed by the locking elements along a comparatively large surface area.

It may advantageously be provided that the door is assigned a gear mechanism which causes the door leaf to move relative to the door frame by means of an eccentric, which is mounted in a rotatable manner on the door frame or the door leaf and is supported on the respectively other part of the door.

If the door is assigned a gear mechanism for generating the relative movement, then the movement can be achieved with only a small amount of force being applied. Using a rotatably mounted eccentric, in addition, gives rise to an extremely robust and cost-effective configuration of such a gear mechanism.

It may advantageously be provided, inter alia, that the eccentric has at least one end stop, which inhibits the ability of the gear mechanism to move in the end positions.

If the eccentric is assigned an end stop, the latter inhibits the ability of the gear mechanism to move in the end positions. Overtravel of the eccentric is thus easily avoided. At the same time, incorrect operation of the gear mechanism is ruled out since it is only possible for the latter to be transferred from one of the end positions into the respectively other end position only in a certain movement sequence.

It may further be provided that the movement of the door leaf can be limited by the eccentric.

If the eccentric limits the movement of the door leaf, then it is not possible to force movement of the gear mechanism by movement of the door leaf. For this purpose, the eccentric has flattened portions on its running surface. These flattened portions strike against corresponding stops, this resulting in blockage of movement of the door leaf in relation to the gear mechanism.

A further advantageous configuration provides that the gear mechanism has a displaceable catch which, in one of its positions, prevents a drive device, in particular a drive lever, from being attached to the gear mechanism.

A displaceable catch easily prevents a drive device, for example a drive lever, from being attached to the gear mechanism. This results in unauthorized operation of the gear mechanism being ruled out. Since the attachment of a drive device is already prevented, it is thus necessary to dispense with an otherwise necessary locking device in the gear mechanism itself. It may further advantageously be provided that the catch can be arrested in a first position with the aid of a lock.

If the catch can be arrested in a first position by means of a lock, then unauthorized operation of the displaceable catch is prevented. Only correspondingly authorized individuals are capable of disengaging the catch.

The invention is presented by way of an exemplary embodiment in a drawing and described in more detail hereinbelow. In the drawing:

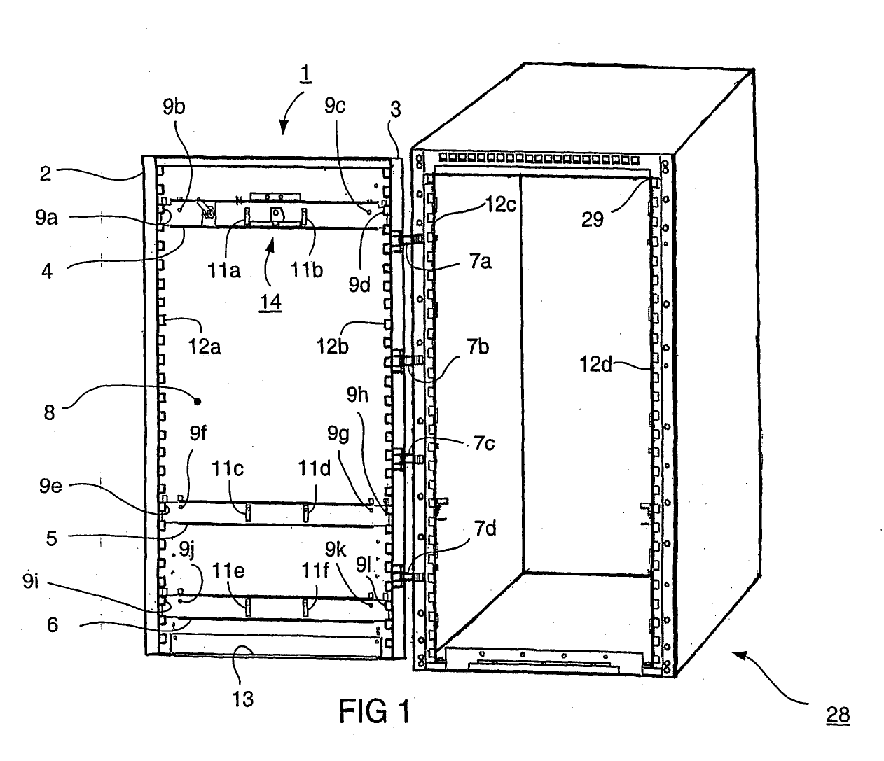

FIG. 1 shows a view of the door from the inside,

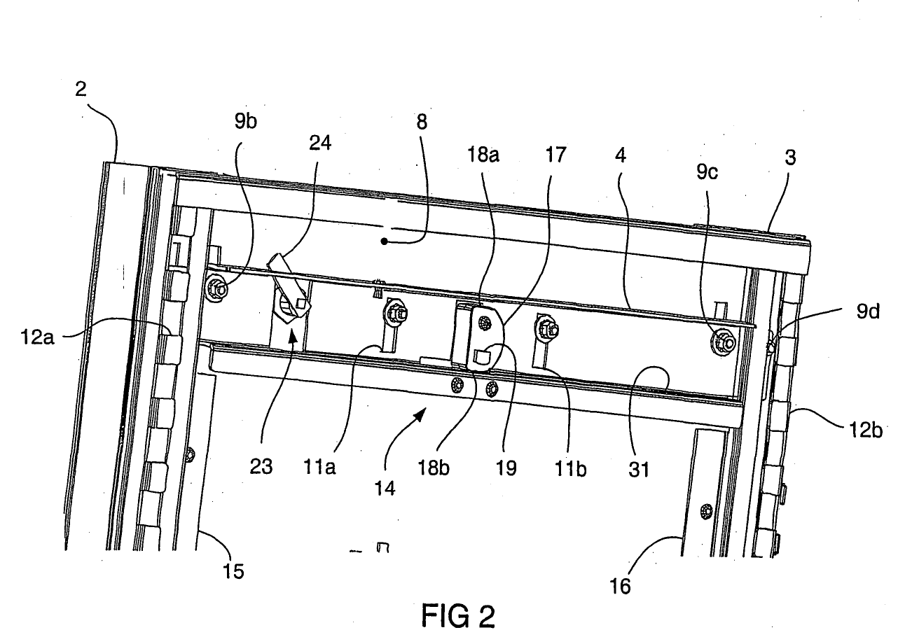

FIG. 2 shows a perspective view of part of the gear mechanism with a raised door leaf,

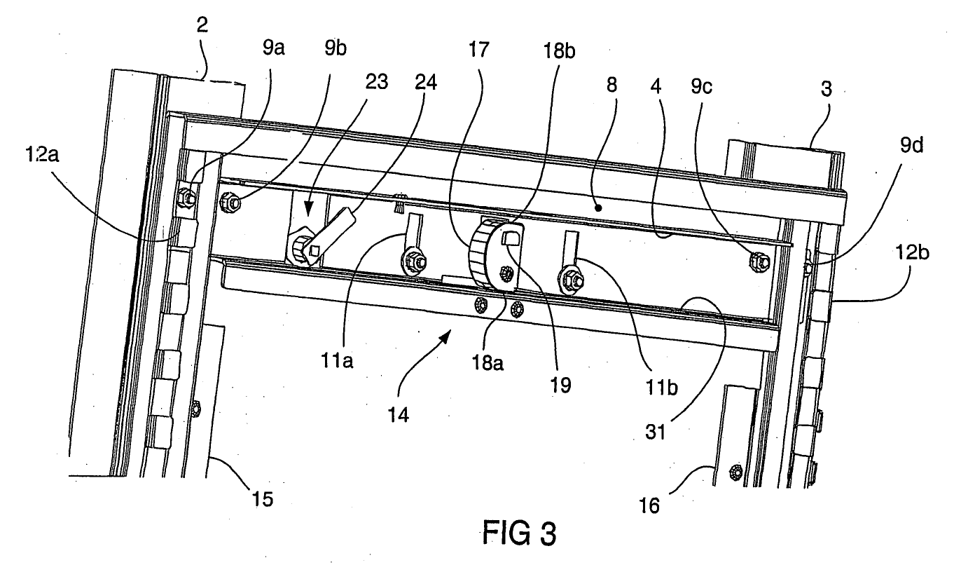

FIG. 3 shows a perspective view of part of the gear mechanism with a lowered door leaf,

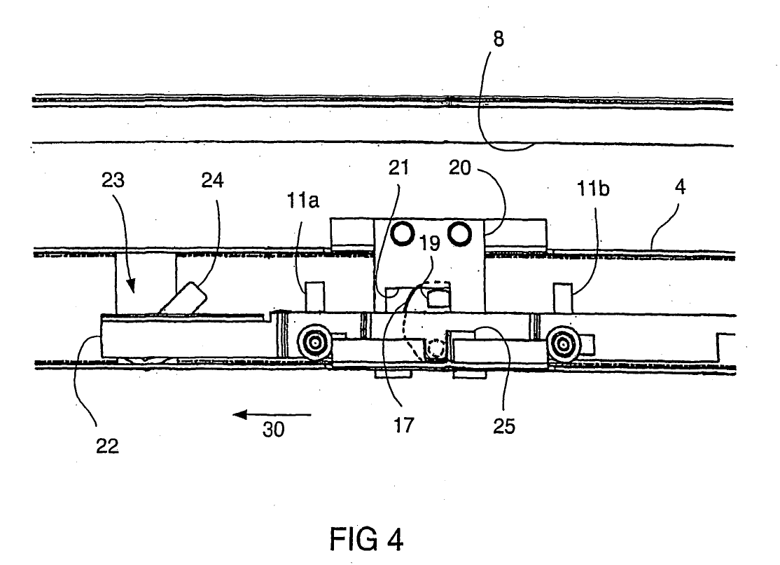

FIG. 4 shows a side view of the gear mechanism, and

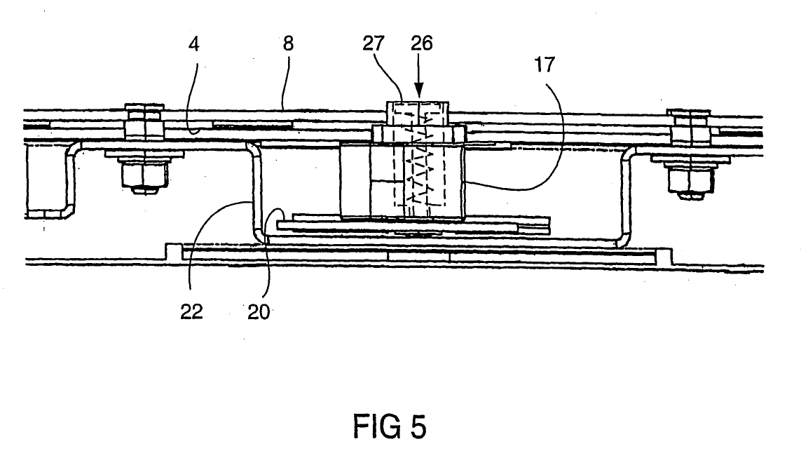

FIG. 5 shows a plan view of the gear mechanism.

The inside view of a door 1 of a switch cabinet 28 for electrical switchgear which is illustrated in FIG. 1 has a first longitudinal member 2 and a second longitudinal member 3. The first and the second longitudinal members 2, 3 are connected to one another at a fixed angle by a first crossmember 4, a second crossmember 5 and a third crossmember 6. The longitudinal members 2, 3 and the crossmembers 4, 5, 6 form the door frame of the door 1. This door frame produces the necessary mechanical strength for the door 1. A plurality of hinges 7a,b,c,d are arranged on the second longitudinal member 3. These hinges 7a,b,c,d serve for attaching the door 1 to a switch-cabinet frame 29, with the result that the door 1 can be pivoted. The crossmembers 4, 5, 6 have essentially a U-shaped profiling. The longitudinal members 2, 3 and the crossmembers 4, 5, 6 are connected to one another at a fixed angle, and at a distance apart, by means of bolts 9a,b,c,d,e,f,g,h,i,k,l, to be precise such that an interspace is produced, perpendicularly to the drawing plane, between the longitudinal members 2, 3 and the crossmembers 4, 5, 6, a door leaf 8 being arranged in said interspace. The door leaf 8 has slots through which the bolts 9a,b,c,d,e,f,g,h,i,k,l pass, these bolts guiding the door leaf 8 relative to the door frame formed from the longitudinal members 2, 3 and crossmembers 4, 5, 6. In order to assist the guidance of the door leaf 8, the crossmembers 4, 5, 6 have further slots 11a,b,c,d,e,f, through which are guided bolts which are connected to the door leaf at a fixed angle. On the longitudinal sides of the door leaf 8, the door leaf 8 is profiled in a comb-like manner. These comb-like profilings constitute first locking elements 12a,b. Second locking elements 12c,d are arranged on the switch-cabinet frame 29. A floor profile 13 is arranged on the door leaf 8 in the floor region.

FIGS. 2 and 3 show, in detailed form, a region of the door 1 with the first crossmember 4. In FIG. 2, the door leaf 8 has been raised in relation to the door frame. In FIG. 3, the door leaf 8 has been lowered in relation to the door frame. The operations of raising and lowering the door leaf take place by means of a gear mechanism 14 which is arranged on the first crossmember 4. In each case the first and the second longitudinal member 2, 3 and the first crossmember 4 can be seen in FIGS. 2 and 3. The moveable door leaf 8 is arranged between the longitudinal members and crossmembers 2, 3, 4, 5, 6, which are spaced apart but arranged at a fixed angle to one another. Fastened on the moveable door leaf 8 are a first sealing profile 15 and a second sealing profile 16. The movement of the door leaf 8 is guided by bolts 9a, 9b, 9c, 9d, which are assigned to the door frame and pass through slots located in the door leaf 8. In addition, the first crossmember 4 has further slots 11a, 11b, which have bolts which are connected to the door leaf at a fixed angle passing through them and which aid the guidance of the door leaf 8. Mounted in a rotatable manner in the door leaf 8, an eccentric 17 is arranged on the first crossmember 4. Via the eccentric 17, the door leaf 8 is supported on a leg 31 of the first crossmember 4, said leg being located perpendicularly to the door leaf 8. By virtue of the eccentric 17 being rotated through 180°, the door leaf 8 is transferred from its raised position, which is illustrated in FIG. 2, into the lowered position, which is illustrated in FIG. 3, and vice versa. In order to ensure intrinsically safe mounting of the door leaf 8 in the end positions, the eccentric has two more or less parallel bearing surfaces 18a,b. The door leaf rests on these bearing surfaces 18a,b in each case in the lowered position and the raised position. By virtue of this design, it is not possible to displace the door leaf 8 without operating the gear mechanism 14. Both in the raised state and in the lowered state, the bearing surfaces 18a,b of the eccentric 17 block this movement. In addition, an end stop 19 is arranged laterally on the eccentric 17.

FIG. 4 illustrates, in detail form, the first crossmember 4 in a side view from the inside of the door. The gear mechanism 14, which is depicted in FIGS. 2 and 3, is illustrated in complete form in FIG. 4. In addition, a covering plate 20 is mounted in front of the eccentric 17, said covering plate serving for guiding the eccentric 17 and having a cutout 21 in which the laterally arranged end stop 19 of the eccentric 17 can be moved. Interaction of the covering plate 20 and the end stop 19 of the eccentric 17 ensures that the eccentric 17 can only be moved in the respectively admissible direction of rotation. This means that the end positions cannot be exceeded.

A catch 22 is provided in addition. This catch 22 can be moved and arrested by means of a lock 23. For this purpose, the lock has a rotatable tongue 24 which moves the catch 22 along the first crossmember 4. The catch 22 is guided on the bolts which are connected to the door leaf 8 at a fixed angle. The catch 22 has a recess 25 which, in the unlocked state, is located in the region of the axis of rotation of the eccentric 17. In the locked state of the catch 22, the region of the axis of rotation of the eccentric 17 is covered over by the catch 22 (as is illustrated in FIG. 4).

The layered construction of the gear mechanism 14 with the door leaf 8, the first crossmember 4, the eccentric 17 and the catch 22 can be gathered in a plan view from FIG. 5. The eccentric 17 has a socket-like recess 26 along its axis of rotation on the outside of the door 1. A spring-loaded blocking bolt 27 is arranged in this socket-like recess 26. In the unlocked state of the catch 22, that is to say with the recess of the catch 22 located in front of the axis of rotation of the eccentric 17, the blocking bolt 27 can be displaced in the direction of the inside of the door, that is to say, for example, an operating lever can be introduced into the socket-like recess 26, said operating lever moving the blocking bolt 27 into the interior of the cabinet during introduction. This blocking bolt 27 is spring-loaded, with the result that it moves back into its starting position again once the operating lever has been removed. If the catch 22 is located in its locking position, it is not possible to move the blocking bolt 27 into the interior of the cabinet since it is blocked by the catch 22. The eccentric 17 cannot be actuated from the outside. As an alternative to such a mechanism, it is conceivable for the socket-like recess 26 of the eccentric 17 to be closed by a covering on the outside of the door, said covering being connected to the catch 22.

The sequence of operations involved in unlocking a door 1 according to the invention is described hereinbelow. The starting point is the locked state, which is illustrated in FIGS. 3 and 4. The door 1 is closed, the door leaf 8 is lowered, and the first locking elements 12a,b, which are arranged on the door leaf 8, engage with the second locking elements 12c,d, which are arranged on the switch-cabinet frame 29. In the first instance, using a key introduced into the lock 23, a rotary movement of the tongue 24 causes the catch 22 to be moved, in the direction of the arrow 30, into an unlocked position. It is then possible for an actuating lever to be introduced into the socket-like recess 26 of the eccentric 17. By virtue of the eccentric 17 being rotated through 1800, the door leaf 8 is raised and the first locking elements 12a,b are disengaged from the second locking elements 12c,d. The door 1 has been unlocked. It is now possible to open the door 1 including the door frame. The operations of closing the door 1 and of lowering the door leaf 8 take place correspondingly in reverse order.

1. A switch cabinet (28) for electrical switchgear, having a door (1) which can be moved in relation to a switch-cabinet frame (29) and has a door frame (2, 3, 4, 5, 6), which provides the door (1) with mechanical stability, and a door leaf (8), which is arranged on the door frame (2, 3, 4, 5, 6), characterized in that the door leaf (8) can be moved relative to the door frame (2, 3, 4, 5, 6) and the door leaf (8) is assigned first locking elements (12a,b) which can be locked with second locking elements (12c,d) assigned to the switch-cabinet frame (29), and unlocked therefrom, by virtue of the ability of the door leaf (8) to move in relation to the switch-cabinet frame (29).

2. The switch cabinet (28) for electrical switchgear as claimed in claim 1, characterized in that, with the door frame (2, 3, 4, 5, 6) fixed in the closed position of the door (1), the door leaf (8) can be moved in relation to the switch-cabinet frame (29).

3. The switch cabinet (28) for electrical switchgear as claimed in claim 1 or 2, characterized in that the first and the second locking elements (12a,b,c,d) are each of comb-like design.

4. The switch cabinet (28) for electrical switchgear as claimed in one of claims 1 to 3, having a pivotable door (1) attached on one side to the switch-cabinet frame (29), characterized in that the first locking elements (12a,b) are arranged on a door edge which is located opposite an attached door edge.

5. The switch cabinet (28) for electrical switchgear as claimed in one of claims 1 to 4, characterized in that the first locking elements (12a,b) are each arranged along two parallel door edges.

6. The switch cabinet (28) for electrical switchgear as claimed in one of claims 1 to 5, characterized in that the door is assigned a gear mechanism (14) which causes the door leaf (8) to move relative to the door frame (2, 3; 4, 5, 6) by means of an eccentric (17), which is mounted in a rotatable manner on the door frame (2, 3, 4, 5, 6) or the door leaf (8) and is supported on the respectively other part of the door (1).

7. The switch cabinet (28) for electrical switchgear as claimed in claim 6, characterized in that the eccentric (17) has at least one end stop (19), which inhibits the ability of the gear mechanism (14) to move in the end positions.

8. The switch cabinet (28) for electrical switchgear as claimed in either of claims 5 and 6, characterized in that the movement of the door leaf (8) can be limited by the eccentric (17).

9. The switch cabinet (28) for electrical switchgear as claimed in one of claims 6 to 8, characterized in that the gear mechanism (14) has a displaceable catch (22) which, in one of its positions, prevents a drive device, in particular a drive lever, from being attached to the gear mechanism (14).

10. The switch cabinet (28) for electrical switchgear as claimed in claim 9, characterized in that the catch (22) can be arrested in a first position with the aid of a lock (23).
